(19) United States
(12) Patent Application Publication
(10) Pub. No.: US 2020/0055402 A1
(43) Pub. Date: Feb. 20, 2020

(54) ADAPTIVE OFF-THROTTLE REGENERATIVE BRAKING

(71) Applicant: SF Motors, Inc., Santa Clara, CA (US)

(72) Inventors: Jaime Camhi, Santa Clara, CA (US); Avery Jutkowitz, Santa Clara, CA (US)

(21) Appl. No.: 16/103,712

(22) Filed: Aug. 14, 2018

(51) Int. Cl. B60L 7/18; B60T 7/12; B60T 8/171; B60T 8/17; B60T 8/32

(52) U.S. Cl. CPC B60L 7/18; B60T 7/12; B60T 8/171; B60T 8/17; B60L 2240/68; B60L 2240/64; B60L 2240/12; B60L 2240/622; B60T 8/3215

(57) ABSTRACT

Provided herein are systems and methods of automatic off-throttle regenerative braking in electric vehicles. One or more sensors disposed in an electric vehicle can acquire one or more sensor signals indicative of one or more respective driving parameters of the electric vehicle. A data processing system of the electric vehicle can determine, using the one or more sensor signals, one or more current driving conditions of the electric vehicle. The data processing system of the electric vehicle can determine, using the one or more current driving conditions, a future driving state indicative of an imminent future slowdown event. The data processing system of the electric vehicle can cause a regenerative braking system of the electric vehicle to apply regenerative braking, responsive to determining the future driving state.

### BACKGROUND

Vehicles can include braking mechanisms for obstacle avoidance or to slow down or stop while driving. The braking mechanisms can reduce or stop the forward momentum or velocity of the vehicle.

### SUMMARY

The present disclosure is directed to systems and methods for automatic (or adaptive) off-throttle regenerative braking in electric (e.g., fully electric, hybrid, or otherwise electrified) vehicles, including hybrid vehicles and all-electric vehicles. The disclosed systems and methods can allow for improving the driving range of electric vehicles and enhance drivers' experience by employing an adaptive electric regeneration strategy. The adaptive electric regeneration strategy can allow for determining when to apply regenerative braking and the level of regenerative braking to be applied to an electric vehicle depending on the current driving condition of the electric vehicle. The disclosed systems and methods can determine the driving condition of the electric vehicle using sensor data obtained from sensors disposed in the electric vehicle. The disclosed system and methods can be incorporated into a hybrid vehicle, a fully electric (or all-electric) vehicle, an autonomous electric vehicle (e.g., with self-driving capabilities), or a combination thereof.

At least one aspect is directed to a system for automatic off-throttle regenerative braking in electric vehicles. The system can include a first sensor disposed in an electric vehicle, a second sensor disposed in the electric vehicle, and a data processing system of the electric vehicle. The first sensor can provide a first sensor signal indicative of a first driving parameter of the electric vehicle. The second sensor can provide a second sensor signal indicative of a second driving parameter of the electric vehicle. The data processing system of the electric vehicle can include a communications interface, a data analysis component, and an electric regeneration triggering component. The communications interface can receive the first and second sensor signals from the first and second sensors, respectively. The data analysis component can determine, using the first and second sensor signals, one or more current driving conditions of the electric vehicle. The data analysis component can determine, using the one or more current driving conditions, a future driving state indicative of an imminent slowdown of the electric vehicle velocity. The electric regeneration triggering component can cause a regenerative braking system of the electric vehicle to apply regenerative braking, responsive to determining the future driving state.

At least one aspect is directed to a method of automatic off-throttle regenerative braking in electric vehicles. The method can include sensing, by one or more sensors disposed in an electric vehicle, one or more sensor signals indicative of one or more respective driving parameters of the electric vehicle. The method can include a data processing system of the electric vehicle determining, using the one or more sensor signals, one or more current driving conditions of the electric vehicle. The method can include the data processing system of the electric vehicle determining, using the one or more current driving conditions, a future driving state indicative of an imminent slowdown of the electric vehicle velocity. The method can include the data processing system of the electric vehicle causing a regenerative braking system of the electric vehicle to apply regenerative braking, responsive to determining the future driving state.

At least one aspect is directed to an electric vehicle. The electric vehicle can include a first sensor disposed in the electric vehicle, a second sensor disposed in the electric vehicle, and a data processing system. The first sensor can provide a first sensor signal indicative of a first driving parameter of the electric vehicle. The second sensor can provide a second sensor signal indicative of a second driving parameter of the electric vehicle. The data processing system can include a communications interface, a data analysis component, and an electric regeneration triggering component. The communications interface can receive the first and second sensor signals from the first and second sensors, respectively. The data analysis component can determine, using the first and second sensor signals, one or more current driving conditions of the electric vehicle. The data analysis component can determine, using the one or more current driving conditions, a future driving state indicative of an imminent slowdown of the electric vehicle velocity. The electric regeneration triggering component can cause a regenerative braking system of the electric vehicle to apply regenerative braking, responsive to determining the future driving state.

At least one aspect is directed to a computer-readable medium storing computer code instructions for automatic off-throttle regenerative braking in electric vehicles. The computer code instructions, when executed by one or more processors, can cause the one or more processors to receive, from one or more sensors disposed in an electric vehicle, one or more sensor signals indicative of one or more respective driving parameters of the electric vehicle. The computer code instructions, when executed by one or more processors, can cause the one or more processors to determine, using the one or more sensor signals, one or more current driving conditions of the electric vehicle. The computer code instructions, when executed by one or more processors, can cause the one or more processors to determine, using the one or more current driving conditions, a future driving state indicative of an imminent slowdown of the electric vehicle velocity. The computer code instructions, when executed by one or more processors, can cause the one or more processors to trigger a regenerative braking system of the electric vehicle to apply regenerative braking, responsive to determining the future driving state.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a diagram an example depicted is an example electric vehicle;

FIG. 2 depicts a block diagram of an example automatic regenerative braking system;

FIG. 3 depicts a flowchart of an example method of automatic regenerative braking; and

FIG. 4 is a block diagram depicting a general architecture for a computer system that can be employed to implement elements of the systems and methods described and illustrated herein.

### DETAILED DESCRIPTION

Following below are more detailed descriptions of various concepts related to, and implementations of, methods, apparatuses, and systems of adaptive off-throttle regenerative braking. The various concepts introduced above and discussed in greater detail below may be implemented in any of numerous ways.

Regenerative braking is a mechanism that can be used by electric vehicles to recover electric energy when braking. The electric motor of an electric vehicle can transform the excess of the vehicle's kinetic energy, when slowing down, into electric energy that can be stored in the electric vehicle's battery for use at a later time. An electric vehicle can use off-throttle regenerative braking as a mechanism to recover energy and extend its driving range. The electric motor of the electric vehicle can transform the excess of the vehicle's kinetic energy, when slowing down, into electric energy that can be stored in the electric vehicle's battery for use at a later time. The electric vehicle can recover energy that would be otherwise lost, for example, to the brake discs as heat. By feeding the recovered energy back to the vehicle's battery, the electric vehicle can increase the driving range per full battery charge. As used herein, an electric vehicle can include a hybrid vehicle or an all-electric (or fully electric) vehicle.

The feature of off-throttle regeneration can be set to off, low, or high in the electric vehicle. Each of these regeneration modes can be useful in different driving conditions. For instance, the level of regenerative braking can depend on the amount of deceleration desired. In a case where the electric vehicle is to stop, a high level of regenerative braking can be desired. In a case of a temporary slowdown, however, a low level of regenerative braking may be desired. Also, in a case where the driver is just coasting, no regenerative braking would be desired. The vehicle's driver can manually select one of the electric regeneration modes. Once a selection is made, regenerative braking would be applied according to the selected mode. However, the vehicle can encounter many different driving conditions and can transition from one driving condition to another over the course of a single trip and none of the single electric regeneration modes may be optimal for the entire trip.

The variety and dynamic nature of driving conditions that may be encountered in a single trip calls for (or suggests) an adaptive electric regeneration strategy. The adaptive electric regeneration strategy can involve an understanding (or detection) of the road situation, the maneuver of the driver (e.g., slow down, coast, maintain speed and distance to leading vehicle, roll through a turn, etc.), traffic condition ahead of the vehicle, or a combination thereof. The adaptive electric regeneration strategy can allow for determining whether or not to apply regenerative braking depending on the driving condition. The adaptive electric regeneration strategy may also allow for determining the level of the regenerative braking to be applied, or switching between different regeneration modes, based on the driving condition. By allowing for adaptive determination of when to apply regenerative braking and the regenerative braking level to be applied, adaptive electric regeneration can improve the driving range of the electric vehicle and enhance driver's experience.

The electric vehicle can be equipped with a plurality of sensors, one or more navigation devices, one or more communication devices, or a combination thereof to acquire information related to, for example, the type of road (e.g., closed access highway, rural roads, or urban streets) being traveled on, traffic conditions, road topography, geolocation, vehicle orientation, or a combination thereof. The electric vehicle, or a data processing system thereof, can use the acquired information to predict or anticipate imminent future stop events or imminent future slowdown events. The electric vehicle can determine a level of electric regeneration (or an electric regeneration mode) based on the anticipated event, and apply regenerative braking according to the determined electric regeneration level or mode. The electric vehicle, or the data processing system thereof, can automatically and regularly adjust the amount of off-throttle electric regeneration based on data continuously (or regularly) acquired by the sensors, navigation device(s), communication device(s), or a combination thereof. As used herein, the sensors can include a variety of devices, including but not limited to radar sensors, speed sensors, maintenance sensors, battery sensors, pedal sensors, navigation devices, communication devices, camera devices, or a combination thereof, that are used to acquire information related to driving parameters of the electric vehicle, such as the type of road (e.g., closed access highway, rural roads, or urban streets) being traveled by the electric vehicle, road topography, vehicle geolocation, vehicle orientation, vehicle speed, distance to and speed of nearby vehicles, traffic conditions, actuation status of one or more pedals, vehicle maintenance alerts, battery recharge alerts, or a combination thereof.

Described herein are systems and methods of automatic off-throttle regenerative braking. The disclosed systems and methods can allow for sensors disposed in an electric vehicle to regularly acquire data indicative of driving parameters of the electric vehicle. A data processing system of the electric vehicle can analyze the acquired data to determine one or more current driving conditions of the electric vehicle. The one or more current driving conditions can be indicative of, for example, the vehicle speed relative to the speed of one or more nearby vehicles, the vehicle geolocation and driving direction relative to a reference point (e.g., traffic light, stop sign, a location associated with a traffic jam or traffic accident, road curve or crossing, road exit, or a combination thereof), distance(s) between the electric vehicle and one or more other vehicle(s), traffic condition along the road on which the electric vehicle is traveling, battery charge level, actuation status of the gas/speed pedal, or a combination thereof. The data processing system may use driver preferences or driver historical data to determine the one or more current driving conditions. The data processing system can determine a future driving state of the electric vehicle of a plurality of driving states using the one or more current driving conditions. The future driving state of the electric vehicle can be indicative of a future imminent slowdown event of the electric vehicle. The data processing system can cause a regenerative braking system of the electric vehicle to apply regenerative braking, responsive to the future driving state. The data processing system may determine a regenerative braking level based on the future driving state, and cause the regenerative braking system of the electric vehicle to apply regenerative braking according to the regenerative braking level.

The disclosed adaptive off-throttle electric regeneration techniques have technical advantages relative to, for example, static off-throttle electric regeneration approaches. In an electric vehicle employing static off-throttle electric regeneration approaches, the regenerative braking system applies off-throttle regenerative braking according to an actuated electric regeneration mode regardless of the driving conditions of the electric vehicle. For instance, when electric regeneration is on (e.g., with a high or low regeneration level), the regenerative braking system may apply regenerative braking even when the electric vehicle is in free coasting state (e.g., the driver lifts his foot off the gas/speed pedal but does not intend to stop or to slow down significantly). The energy recovered through regenerative braking is typically less than the energy needed to regain the vehicle speed, and the regenerative braking applied during the free coasting state leads to a decrease in the driving range. Loss in cumulative energy may also result if the regenerative braking system applies a higher level of regenerative braking than desired and reduce the vehicle's speed to a level smaller than that intended by the vehicle's driver.

The adaptive off-throttle electric regeneration techniques disclosed herein allow for improving the efficiency of regenerative braking by optimizing the electric regeneration level to be applied based on the driving conditions of the electric vehicle. Specifically, the systems, devices, and methods described in this disclosure allow for getting better driving range on the electric vehicle by letting the electric vehicle to coast under certain driving conditions, and applying regenerative braking in other driving conditions that suggest an imminent future slowdown event (e.g., a stop event or a partial speed reduction event). The adaptive nature of off-throttle electric regeneration based on detected driving conditions allows for increased energy recovery through regenerative braking and improved driving range of the electric vehicle. The efficiencies offered by the off-throttle electric regenerative braking described herein can increase battery life by applying additional charge to the battery during electric vehicle operation.

The adaptive off-throttle electric regeneration techniques disclosed herein also allow for enhanced driver experience and comfort. First, the disclosed techniques allow for avoiding or mitigating aggressive slowing down when the driver of the electric vehicle wishes to coast freely (e.g., maintain a speed through a turn or freeway). Furthermore, the adaptive (or dynamic) nature of regenerative braking relieves the driver from manually switching from one regenerative braking mode (or level) to another while driving. Also, adaptive off-throttle electric regeneration techniques disclosed herein do not expect the driver of the electric vehicle to be knowledgeable of the various regenerative braking levels and which level to select or apply depending on the driving conditions.

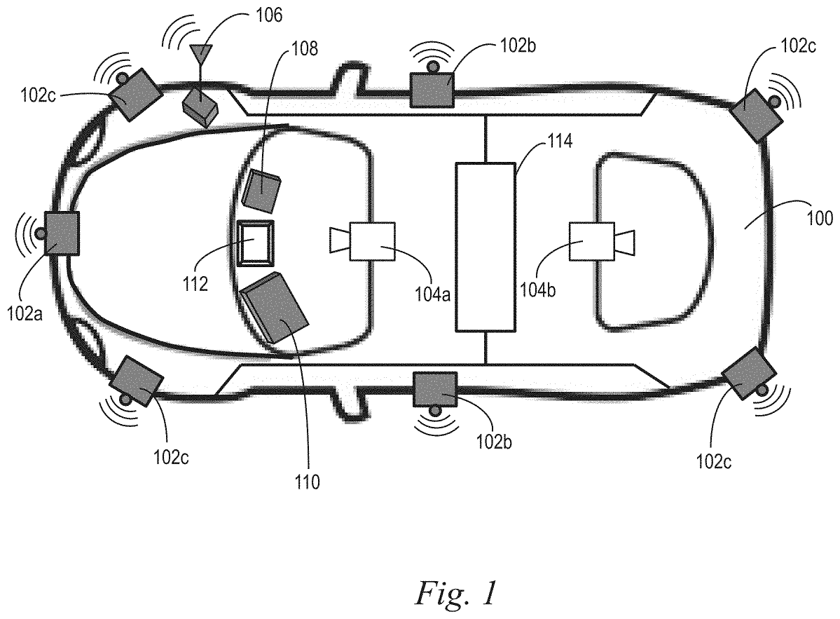

FIG. 1 depicts an example electric vehicle 100. The electric vehicle 100 can include a plurality of radar sensors 102a-102c (referred to hereinafter individually or collectively as radar sensor(s) 102). The electric vehicle 100 can include one or more image sensors such as image sensors 104a and 104b (also referred to hereinafter individually or collectively as image sensor(s) 104). The electric vehicle 100 can include a communication transceiver 106 for receiving data from remote data sources. The electric vehicle 100 can include a navigation device 108. The electric vehicle 100 can include a computing device 110 for executing instructions to perform adaptive off-throttle electric regeneration techniques described herein. The electric vehicle 100 can include a display device 112 for displaying visual information to the vehicle's driver. The electric vehicle 100 can include a regenerative braking system 114 for applying regenerative braking. The plurality of radar sensors 102, the one or more image sensors, the radio transceiver 106, the navigation device 108, the display device 112 and the regenerative braking system 114 can be communicatively coupled to the computing device 110. The electric vehicle 100 may include other sensors, such as a vehicle speed sensor (VSS), a battery sensor, one or more pressure monitoring sensors to monitor wheel pressure, one or more engine sensors, or a combination thereof. These other sensors can be communicatively couples to the computing device 110. The electric vehicle 100 as described in this disclosure can be an all-electric (or fully electric) vehicle or a hybrid vehicle. The electric vehicle 100 can be an autonomous vehicle that can operate in autonomous or manual (e.g., self-driving) modes of operation. The electric vehicle 100 can also be a non-autonomous vehicle that only operates in a manual or self-driving mode of operation where a human operator drives the electric vehicle 100. The processes and adaptive regenerative techniques described throughout this disclosure are applicable to all-electric and hybrid vehicles.

The plurality of radar sensors 102 can radiate electromagnetic waves and receive echoes of the electromagnetic waves reflected from obstacles in the vicinity of the electric vehicle 100. The plurality of radar sensors 102 may include a light imaging detection and ranging (LIDAR) radar sensor that can emit laser light pulses and detect nearby objects based on received reflections of the laser light pulses. The plurality of radar sensors 102 can include a front radar sensor 102a, one or more side radar sensors 102b, and one or more corner radar sensors 102c. The front radar sensor 102a, as the name suggests, can be arranged to point forward relative to the electric vehicle 100, and can detect the presence of other vehicle (or other obstacles) ahead of the electric vehicle 100. The front radar sensor 102b can also detect the distance to any other vehicle (or other obstacle) that is ahead of the electric vehicle 100 based on the travel time of the emitted electromagnetic wave or signal.

Each side radar sensor 102b can be arranged on one side of the electric vehicle 100 and can have an orientation transverse to the orientation of the electric vehicle 100. The side radar sensors 102b can detect other vehicles (or other obstacles), if any, located adjacent to the electric vehicle 100, for example, in a lane adjacent to that occupied by the electric vehicle 100. Each corner radar sensor 102c can be oriented along a corresponding corner of the electric vehicle 100. The corner radar sensors 102c can detect other vehicles (or other obstacles), if any, located on either sides, and relatively ahead or relatively behind, of the electric vehicle 100. The side radar sensors 102b and the corner radar sensors 102c may have a shorter detection range compared to the detection range of the front radar sensor 102a. In combination, the front radar sensor 102a, the side radar sensors 102b, and the corner radar sensors 102c can detect other vehicles (or other obstacles), if any, at different angles or positions in the surrounding of the electric vehicle 100. While the electric vehicle 100 is shown to include one front radar sensor 102a, two side radar sensors 102b and four corner radar sensors 102c, other combinations of such radar sensors 102 can be employed. For example, the electric vehicle 100 may include either side radar sensors 102b or corner radar sensors 102c, or both. Also, the number of each type of radar sensors may vary from one electric vehicle to another.

The radar sensors may regularly emit electromagnetic waves or signals to detect any obstacles or other vehicles in the surrounding of the electric vehicle 100. The electric vehicle 100 may include a user interface icon (e.g., rendered on the display device 108) or a button to activate or deactivate the radar sensors 102. The radar sensors 102 may be automatically activated by the computing device 110 or other electronic device of the electric vehicle 100, for example, upon starting the electric vehicle 100. The radar sensors 102 can determine the distance to, the location of, and the size of any obstacle or other vehicle detected to be within the vicinity of the electric vehicle 100. The radar sensors 102 can provide information indicative of detected objects or other vehicles and the corresponding locations, sizes, distances from the electric vehicle 100, or a combination thereof to the computing device 110.

The electric vehicle 100 can include one or more image sensors 104. The image sensors 104 can include a video camera device, an image camera device, an infrared camera device, or a combination thereof. The electric vehicle 100 can include an image sensor 104a pointing to the front (or ahead) of the electric vehicle 100. The electric vehicle 100 can include an image sensor 104b pointing to the back (or backward) of the electric vehicle 100. Images, or video sequences captured by the image sensors 104 can provide visual information indicative of the alignment of the electric vehicle 100 relative to lanes of the road on which the electric vehicle 100 is located. The images or video sequences can include visual information indicative of objects or other vehicles situated behind or ahead of the electric vehicle 100. The visual content of the images or video sequences can provide information regarding one or more driving conditions of the electric vehicle, such as the traffic condition ahead of the electric vehicle 100. For example, the images or video sequences can reveal the number of the vehicles ahead of the electric vehicle 100 and whether back lights of these vehicles are on. Having the back lights on can indicate that the vehicles ahead of the electric vehicle 100 are slowing down (or having the brakes on). Also, a relatively large number of vehicles ahead can be indicative of a potential traffic jam or traffic slowdown ahead of the electric vehicle 100. The visual content of the images or video sequences can reveal presence of road signs, traffic lights, pedestrian walkways, or a combination thereof. The images or video sequences may also reveal the status of the traffic lights, if any.

The communication transceiver 106 can be communicatively coupled to the computing device 110 and can receive or transmit radio signals. The communication transceiver 106 can allow for communicating with a remote communications network (not shown in FIG. 1). The communications network can include computer networks such as the Internet, a local area network, a wide area network, a near field communication (NFC) network, a metropolitan area network, a network (e.g., a cellular network), a satellite communications network or a combination thereof. The communications network can include a point-to-point network, broadcast network, telecommunications network, asynchronous transfer mode network, synchronous optical network, or a synchronous digital hierarchy network, for example. The communications network can include at least one wireless link such as a link between the communication transceiver 106 and one or more remote communications devices. The communication transceiver can include a radio transceiver, an infrared transceiver, or a combination thereof.

The communication transceiver 106 can allow the computing device 110 to connect to the Internet or one or more remote computer servers. For instance, the communications transceiver 106 can transmit or receive signals to establish a logical communication link, request online data, or receive data. For example, the computing device 110 can send requests via the communication transceiver 106 to access online geographical data, online traffic data associated with the location of the electric vehicle 100, weather related data, online data related to ongoing road work activities, or a combination thereof. The online geographical data can include road topography data, such as road type, number of lanes for one or more roads, locations of road crossings, locations of traffic lights, locations and types of traffic signs, or a combination thereof. The online traffic data can include information indicative of locations of traffic jams or slow traffic. The information can include indications of traffic flow speed across various segments of each road of a plurality of roads. The online traffic data can include current states (e.g., red, green or orange) for a plurality of traffic lights. The weather data can include information indicative of ambient temperature distribution, rain, snow, wind, visibility, or a combination thereof. The data related to ongoing road work activities can include information indicative of locations of road work activities, number of lanes closed around each road work activity, traffic flow speed around each road work activity, detours if any, or a combination thereof.

The online geographical data, the online traffic data, the weather related data, or the online data related to ongoing road work activities can be provided via one or more websites, one or more online services, or a combination thereof. The computing device 110 can actively request online data from one or more websites or one or more remote computer servers. The computing device 110 can send data requests to the one or more websites or the one or more remote servers. The data requests can identify, for example, the geographic location of the electric vehicle 100, the destination of the electric vehicle 100, the route of the electric vehicle 100, or a combination thereof. The computing device 110 may subscribe to an online service that can regularly push updates of the online geographical data, the online traffic data, the weather related data, or the online data related to ongoing road work activities to electric vehicle 100.

The communication transceiver 106 may receive data from transmitting (or broadcast) devices (not shown in FIG. 1) disposed on the sides of one or more roads or mounted on drones that are designated to monitor roads. Stationary transmitting (or broadcast) devices can be spaced apart along each road, and they can have a relatively short or small transmission range, for example, to avoid signal interference between signals transmitted by neighboring transmitting devices. The transmitting devices can transmit or broadcast radio signals, infrared signals, or other types of signals. Each transmitting device can transmit information indicative of, for example, traffic condition (e.g., average traffic speed), speed limits for one or more roads or road segments, road crossings, traffic signs ahead, traffic lights' locations and statuses, road work activities and detours if any, road curves, or a combination thereof related to the location of the electric vehicle 100 (e.g., ahead of traffic flow in a given direction). The transmitting (or broadcast) devices may broadcast information indicative of gas stations or battery recharge stations, rest areas or restaurants ahead of the electric vehicle 100, road exits, or a combination thereof. Each transmitting (or broadcast) device may broadcast its geographical position information.

The navigation device 108 can include a global navigation satellite system (GNSS) receiver, such as a global positioning system (GPS) receiver. The navigation device 108 can receive satellite positioning signals and determine its location using the satellite positioning signals. The navigation device 108 can determine its location using radio signals transmitted from fixed transmitters. The navigation device 108 may include an electronic map to illustrate, for example, a driving route (or driving directions) of the electric vehicle 100. The navigation device 100 may receive and provide (e.g., for display) traffic information, side road information (e.g., gas stations, battery recharge stations, road exits, rest areas, restaurants, or a combination thereof). The navigation device 108 can be communicatively coupled to the computing device 110. The navigation device 108 can provide the computing device 110 with information indicative of, for example, the current location of the electric vehicle 100, driving route, traffic condition ahead, traffic lights, road crossings, road work activities and route detours if any, alternative routes, or a combination thereof.

The electric vehicle 100 may include other sensors not shown in FIG. 1 that may be communicatively couple to the computing device 110. For example, the electric vehicle 100 may include a vehicle speed sensor (VSS) to measure vehicle transmission output or wheel speed. The electric vehicle 100 may include one or more position sensors, such as a geomagnetic sensor, an accelerometer, or a combination thereof. The electric vehicle 100 may include a gyroscope or an orientation sensor to detect the orientation of the electric vehicle 100. Orientation information provided by the gyroscope or the orientation sensor may allow the computing device 110 to determine, for example, whether, the electric vehicle 100 is changing lanes, driving uphill, driving downhill, driving through a curved portion of the road, or a combination thereof. The electric vehicle 100 may include an ambient temperature sensor, a gas tank monitoring sensor, one or more door sensors, one or more tire pressure sensors, a coolant temperature sensor, one or more engine sensors, or a combination thereof.

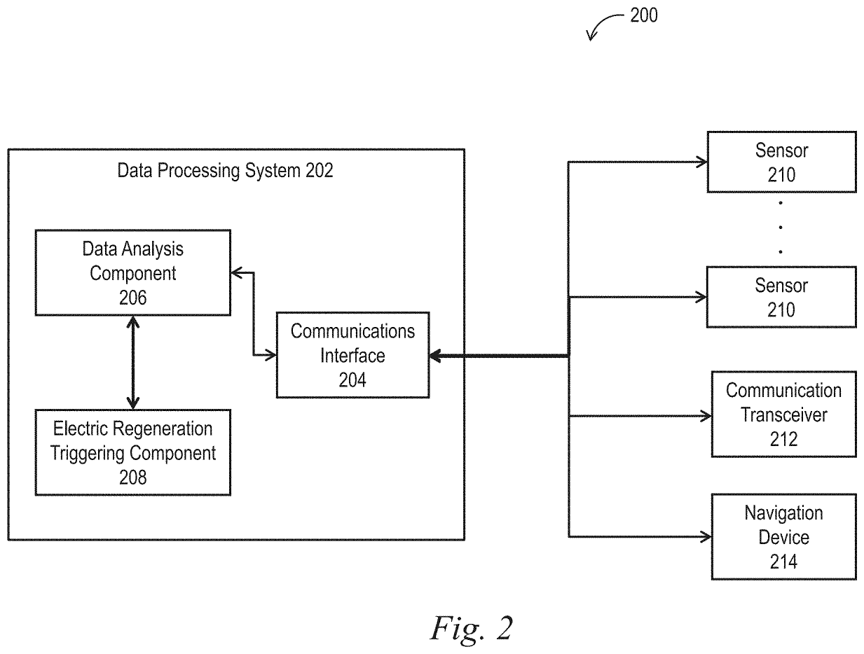

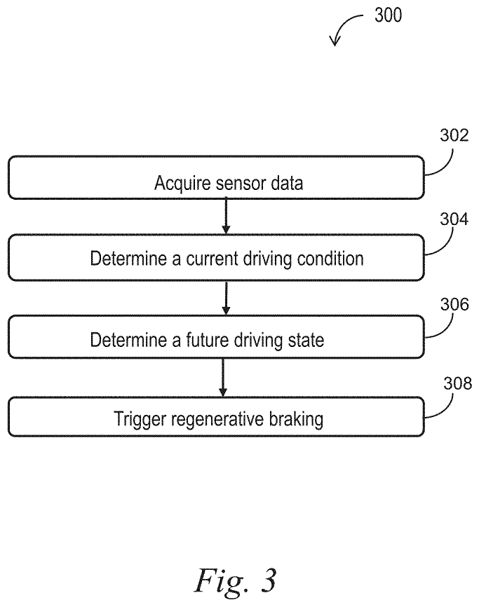

The computing device 110 can include one or more processors and a memory to store computer code instructions. The computing device 110 can include a desktop device, a special purpose logic circuitry, e.g., a field programmable gate array (FPGA) or an application specific integrated circuit (ASIC), a mobile computing device, or a combination thereof. The electric vehicle 10 may include more than one computing device 110. The computing device 110 can receive data from various sensors, remote data sources (e.g., remote computer servers or online services), or a combination thereof, and determine whether or not to apply regenerative braking based on the received data. The computing device 110 may also determine a regenerative braking level to be applied by the regenerative braking system 114. Specifically, the computing device 110 can determine, using data received from the sensors or the remote data sources, whether the driving conditions of the electric vehicle 100 are indicative of an imminent future slowdown. The computing device 110 can select a regenerative braking level to be applied by the regenerative braking system 114 upon detecting an imminent future slowdown of the electric vehicle 100. The processes performed by the computing device 110 are described in further details below with regard to FIGS. 2 and 3.

The display device 112 can be communicatively coupled to the computing device 110. The display device 112 can display a user interface (UI) including an interactive visual component (e.g., an icon, a graphical object, or a swipe bar) to activate or deactivate adaptive (or automatic) regenerative braking. The driver of the electric vehicle 100 can decide whether or not to switch on adaptive regenerative braking. When adaptive regenerative braking is switched on, the computing device 110 can automatically and regularly (periodically or otherwise) determine whether to apply regenerative braking based on sensor data or data received from remote data sources. When adaptive regenerative braking is switched off, either no regenerative braking may be applied or the driver may manually select a static regenerative braking level (or mode) to be applied.

The display device 112 may display indications of traffic conditions, such as traffic flow speed, traffic lights, road crossings and route detours if any, highway exits, or accidents if any ahead of the electric vehicle 100. The display device 112 may display an indication of whether regenerative braking is being applied at any given instant, the level of regenerative braking applied, an indication of the amount of energy saving achieved through adaptive regenerative braking, or a combination thereof. The display device 112 may display alerts or warning messages related to, for example, the amount of battery charge remaining, amount of gas in gas tank, maintenance activities, potential mechanical or electrical defects of the electric vehicle 100, or a combination thereof.

The regenerative braking system 114 can apply a regenerative braking force (or braking torque) to the back wheels of the electric vehicle 100, the front wheels, or both according to regenerative braking levels, for example, specified by the computing device 110. The computing device 110 can determine a regenerative braking level based on sensor data or data received from remote data sources, and provide an indication (or instruction indicative) of the regenerative braking level to the regenerative braking system 114. The regenerative braking system 114 can determine the amount of regenerative braking force (or torque) to be applied to each wheel of the electric vehicle 100 based on, for example, the regenerative braking level, the current speed of the electric vehicle 100, or both. The regenerative braking system 114 may apply a regenerative braking force (or torque) upon the driver of the electric vehicle 100 presses the brake pedal or releases the gas/speed pedal. In the case where the electric vehicle 100 is a self-driving (or autonomous) vehicle, the regenerative braking system 114 may apply the regenerative braking force (or torque) independent of human actions.

The electric vehicle 100 (or the regenerative braking system 114) may support a plurality of regenerative braking levels. Each regenerative braking level may define a corresponding amount of regenerative braking force (or torque) to be applied, a corresponding time duration during which regenerative braking is to be applied, the wheels (e.g., back, front, or both) to which to apply regenerative braking, a corresponding triggering event for initiating regenerative braking (e.g., release of the gas/speed pedal, pressing the brake pedal, or none), or a combination thereof. For example, the regenerative braking levels can include a no-regenerative-braking-level, a low-regenerative-braking-level, a high-regenerative-braking-level, or a combination thereof. For the no-regenerative-braking-level, the amount of regenerative braking force (or torque) may be equal to zero. For the low-regenerative-braking-level, the corresponding regenerative braking force (or torque) may be relatively low (e.g., compared to high-regenerative-braking-level), the corresponding time duration of regenerative braking may be relatively short (e.g., compared to high-regenerative-braking-level), or both. In general, the regenerative braking levels and the number of such levels supported by the electric vehicle 100 (or the regenerative braking system 114) can be defined in various different ways. For example, the number of regenerative braking levels supported by the electric vehicle 100 can be equal to or greater than three. A plurality of time durations of regenerative braking may be associated with a plurality of regenerative braking levels. Also, different regenerative braking levels may be associated with distinct triggering events or different sets of wheels to which to apply regenerative braking. The regenerative braking system 114 may determine a distribution of the amount of regenerative braking force (or torque) associated with a given regenerative braking level among the set of wheels defined in the same regenerative braking level, and apply the regenerative braking force (or torque) accordingly. The regenerative braking levels can be defined, for example, based on the desired speed reduction (e.g., based on specified speed reduction intervals), driving orientation (e.g., straight driving, sharp left turn, left turn curve, sharp right turn, or right turn curve), or a combination thereof.

FIG. 2, depicts an example block diagram of an automatic (or adaptive) regenerative braking system 200 is shown. The automatic (or adaptive) regenerative braking system 200 can include a data processing system 202, for example, implemented in the computing device 110 (shown in FIG. 1). The data processing system 202 can include a communication interface 204, a data analysis component 206, and an electric regeneration triggering component 208. The automatic regenerative braking system 200 can include a plurality of sensors 210, a communication transceiver 212, and a navigation device 214 that are communicatively coupled to the data processing system 202. The automatic regenerative braking system 200 can be disposed in an electric vehicle, such as the electric vehicle 100 of FIG. 1.

Referring to FIGS. 1 and 2, among others, the sensors 210 can include radar sensors 102, one or more image sensors 104, a vehicle speed sensor (VS S), a geomagnetic sensor, an accelerometer, a gyroscope or an orientation sensor, an ambient temperature sensor, a gas tank monitoring sensor, a battery monitoring sensor, one or more vehicle door sensors, one or more tire pressure sensors, a coolant temperature sensor, one or more engine sensors, or a combination thereof. The sensors 210 can generate and provide sensor signals indicative of driving parameters related to the electric vehicle 100, such as vehicle speed, vehicle orientation, ambient temperature, vehicle coolant temperature, tires' pressure levels, battery charging level, distances to other nearby vehicles, velocities of nearby vehicles, or a combination thereof. The communication transceiver 212, as discussed above with regard to the communication transceiver 106 of FIG. 1, can receive information indicative of traffic conditions ahead of the electric vehicle 100, traffic lights' locations and statuses, road work activities and route detours if any, weather conditions, speed limits for one or more roads or road segments, geographic map information, or a combination thereof. The navigation device 214 can detect and provide the current position of the electric vehicle 100, for example, based on satellite navigation signals, wireless signals from cellular base stations, or a combination thereof. The navigation device 214 can provide information related to the driving route or other alternative routes of the electric vehicle 100, traffic conditions, traffic lights, road crossings, traffic signs along one or more routes, facilities (e.g., gas o stations, rest areas, battery charging facilities, restaurants, or a combination thereof) along one or more routes, road exits ahead, or a combination thereof. The communication transceiver 212 and the navigation device 214 can be viewed as sensors (or sensing devices) as both devices provide driving parameters associated with the electric vehicle 100.

The data processing system 202 can be implemented as hardware, firmware, software or a combination thereof. For example, the data processing system 202 can be implemented as (or can include) computer code instructions that can be executed by one or more computing devices such as the computing device 110. The computer code instructions can include instructions related to processes performed by the communications interface 204, the data analysis component 206, the electric regeneration triggering component 208, or a combination thereof. The data processing system 202 may include other components, such as an input/output (I/O) interface, for example, for communicating with the display device 112, the regenerative braking system 114, or other devices of the electric vehicle 100.

The data processing system 202 can receive, e.g., via the communications interface, one or more sensor signals indicative of one or more corresponding driving parameters from the sensors 210, the communication transceiver 212 or the navigation device 214. The communications interface 204 can communicatively couple the sensors 210, the communication transceiver 212, the navigation device 214 or a combination thereof to the data processing system 202. The communication interface 204 can include one or more communication ports to receive sensor signals or data signals from the sensors 210, the communication transceiver 212, the navigation device 214 or a combination thereof. The communication interface 204 may receive the sensor or data signals asynchronously, synchronously, or a combination of both. For example, one or more of the sensors 210, the communication transceiver 212, or the navigation device 214 may push corresponding sensor or data signals to the data processing system 202 according to a periodic pattern, or asynchronously as corresponding driving parameters become available. The communication interface 204 may transform some of the received sensor or data signals into a different format (e.g., demodulated, filtered, amplified, or a combination thereof) that is adequate for processing by the data analysis component 206. The communication interface 204 may extract driving parameters from sensor or data signals and store the driving parameters in a memory accessible by the data analysis component 206. The data processing system 202 may receive one sensor signal from a corresponding sensor device, or multiple sensor signals from multiple corresponding sensor devices, on a regular basis (e.g., every. For instance, the data processing system 202 may receive a first sensor signal indicative of a first driving parameter of the electric vehicle 100 from a first sensor device (e.g., including sensor 210, communication transceiver 212 or navigation device 214), and receive a second sensor signal indicative of a second driving parameter of the electric vehicle 100 from a second sensor device (e.g., including sensor 210, communication transceiver 212 or navigation device 214).

The data processing system 202 (or the data analysis component 206) can determine one or more current driving conditions of the electric vehicle 100 using the received sensor signal(s) or corresponding driving parameter(s). The driving parameters can include parameters that can be measured or reported by the sensor devices (e.g., including sensors 210, communication transceiver 212 or navigation device 214) such as the vehicle's speed, the vehicle's orientation, distance(s) to (or location(s) of) one or more other vehicles or obstacles, speed of one or more other vehicles, average traffic speed in one or more road segments, location(s) and type(s) (e.g., stop sign, yield sign, speed limit sign, school zone sign, sign of merging lanes, or rail road crossing sign) of traffic signs, location(s) and state(s) (e.g., red, green or orange) of traffic lights, distance(s) to one or more road exits ahead, distance to (or location of) traffic accident if any, distance to (or location of) road work activity if any or indication of any closed lanes or detours, navigation path, type of road (e.g., highway, urban road, rural road, number of lanes, or a combination thereof) traveled by the electric vehicle 100, speed limit in the road traveled by the electric vehicle 100, state(s) of brake light(s) of one or more other vehicles, the battery charging level of the electric vehicle 100, tires' pressure levels, coolant temperature, the electric vehicle doors' locked status, maintenance parameters (or alerts) of the electric vehicle 100, weather parameters (e.g., rain, snow, ambient temperature or a combination thereof), self-driving status (e.g., on or off), or a combination thereof.

The location of, or distance to, the other vehicles (or obstacles) ahead and the corresponding speeds can be determined, for example, using sensor signals from the front radar sensor 102a, the image sensor 104a or both. The side radar sensors 102b or the corner radar sensors 102c can determine the location(s) (and/or speeds) of other vehicle(s) on side lane(s), for example, based on reflected echoes of waves or signals transmitted by these radar sensors. The data analysis component 206 may process one or more sensor signals to determine corresponding driving parameters. For example, the data analysis component 206 may perform image analysis (e.g., image segmentation, color histograms, pattern recognition, edge detection, color filtering or a combination thereof) on images or video sequences captured, for example, by the image sensors 104 to detect obstacles or other vehicles in the vicinity (or ahead) of the electric vehicle 100, the state of brake lights of any other vehicles, or a combination thereof. The data analysis component 206 can determine the type of road based on images or video frames acquired by the image sensors 104 or based on signals or messages received by the communication transceiver 212 or the navigation device 214. For instance, the data analysis component 206 may process (e.g., by performing image segmentation, color histograms, pattern recognition, edge detection, color filtering, or a combination thereof) images or video frames captured by the image sensors 104 to determine the type of road or the number of lanes of the road. Transmitting (or broadcast) devices on the side(s) of the road traveled by the electric vehicle 100 may broadcast information indicative of the type of road or the number of lanes in the road. The communication transceiver 212 can receive such information and forward it to the data analysis component 206 via the communications interface 204.

The navigation device 214 may provide indication of the type of the road, the number of lanes, the lane occupied by the electric vehicle 100 or a combination thereof to the data analysis component 206. The communication transceiver 212 may receive information, from online data sources or from transmitting devices on the side(s) of the road, indicative of state(s) of traffic lights ahead, the location of, or distance to, traffic lights, road crossing, traffic signs, curved road segment(s), traffic accident(s), or road work activities, type of traffic signs ahead, traffic condition ahead, closed lanes, detours, weather condition or a combination thereof, and forward the information to the data analysis component 206 via the communications interface 204. The data processing system 202 (or the data analysis component 206) can determine the vehicle speed using signals received from the VSS of the electric vehicle 100, determine maintenance parameters using signals from the tire pressure sensors, coolant temperature sensor or engine sensors. The data processing system 202 (or the data analysis component 206) can determine the remaining gas level using signals from the gas tank monitoring sensor, and determine the battery charging level using signals from the battery monitoring sensor. The data processing system 202 (or the data analysis component 206) can determine the vehicle's orientation using signals from the geomagnetic sensor, the gyroscope, the orientation sensor, the navigation device, or a combination thereof. The vehicle door sensors can provide signals indicative of the locked status of the vehicle doors.

The data analysis component 206 can determine one or more current driving conditions of the electric vehicle 100 using the received sensor signal(s) or corresponding driving parameter(s). The current driving condition(s) can include information related to a road topography of a road traveled by the electric vehicle, a speed (or speed difference) of the electric vehicle 100 relative to a second speed of one or more other vehicles ahead of the electric vehicle 100, a traffic condition ahead of the electric vehicle, a current location of the electric vehicle relative to one or more other vehicles in the vicinity of the electric vehicle, or a combination thereof. Each driving condition can be defined by (or using) a respective set of driving parameters. For example, one driving condition can be indicative of the internal condition (or maintenance condition) of the electric vehicle 100. The internal condition can be defined, for example, by (or using) the vehicle battery charging level, remaining gas level in the gas tank, tires' pressure levels, coolant temperature, vehicle doors' locked status, parameters from engine sensors, or a combination thereof. Another driving condition can relate to the surrounding of the electric vehicle 100 and can be defined, for example, using distance to (or time to) a vehicle or obstacle ahead of the electric vehicle 100, difference between the speed of the electric vehicle 100 and the speed of the vehicle ahead, status of brake light of the vehicle ahead, relative location(s) of (or distance(s) to) vehicle(s) or obstacle(s) on the sides of the electric vehicle 100, difference between the speed of the electric vehicle 100 and the speed(s) of the vehicle(s) on the sides, or a combination thereof. Another driving condition can be indicative of the road condition and can be defined using driving parameters such as the road type, the number of lanes in the road, distance to next road crossing if any, distance to next road curve if any, distance to (or time to) and type of traffic sign(s), distance to (or time to) and status of next traffic lights, distance to (or time to) road work activity if any and the number of lanes closed, road detour if any, or a combination thereof. Another driving condition may relate to traffic condition and can be defined using driving parameters such as average driving speed in one or more road segments, distance to (or time to) each road segment, distance to (or time to) a traffic accident ahead if any, distance to (or time to) and type of traffic sign(s), distance to (or time to) and states of next traffic lights, distance to (or time to) road work activity if any and the number of lanes closed, road detour if any, or a combination thereof.

The data analysis component 206 can define each driving condition as a vector of values or as a single value. The data analysis component 206 can compute the values associated with each driving condition using the values of the driving parameters associated with that driving condition. For example, the data analysis component 206 can compute the time to a reference point (e.g., a vehicle ahead, a set of traffic lights ahead, a road work activity ahead, a road curve, road crossing or road segment ahead, or an accident location) using the distance to that reference point, the speed of the electric vehicle 100, the speed of the reference point, or a combination thereof. The data analysis component 206 can analyze geographical data, such as navigation path maps, locations (or geographical coordinates) of an event (e.g., road work activity or accident) or a reference point (e.g., traffic lights, road segment, road curve, or road crossing) to determine whether the event or the reference point is along the driving path of the electric vehicle 100. Analyzing geographical data can include extracting textual data, processing map images (e.g., using edge detection, image segmentation, color filtering, or a combination thereof), or a combination thereof. If the event or the reference point is determined to be along the driving path of the electric vehicle 100, the data analysis component 206 can determine the distance to (or time to) the event or the reference point using the geographical data, radar sensor data, image sensor data, or a combination thereof.

A driving condition vector can include values representing physical parameters (e.g., distances or driving times to reference points or event locations, traffic lights states, type of road, number of lanes, or average traffic speed) or can include binary values representing results of comparisons of physical parameters to predefined threshold values (or predefined intervals). The data analysis component 206 may compare the values of one or more driving parameters (or other physical parameters related thereof) to corresponding predefined threshold values and use the comparison results as entries of the corresponding driving condition vector(s). For example, the data analysis component 206 may compare the value of distance (or driving time) to a location of a given event location or a given reference point to a corresponding threshold value (e.g., determining whether the driving time to a vehicle ahead is less than 1 minute or 2 minutes) and using the comparison result as an entry in the driving condition vector(s) related to the surrounding the electric vehicle 100, the road condition or traffic condition.

The driving conditions may be defined according to various different implementations. Specifically, the number of driving conditions, the length and content of each driving condition vector, or the driving parameters used to define each driving condition associated may vary for distinct implementations. For example, a driving condition may be defined to indicate the distance (or driving time) to the vehicle ahead. Such driving condition may be defined using a single driving parameter (e.g., distance to vehicle ahead based on sensor signal from front radar sensor 102), and the corresponding driving condition vector may include a single value. In another example, a single driving condition may be defined with a corresponding driving condition vector including determined using all acquired driving parameters.

The data analysis component 206 may update the driving condition vector(s) on a regular basis (e.g., periodically or otherwise) using driving parameters acquired from corresponding sensor devices. As such, the driving condition vector(s) can reflect the current driving condition(s) of the electric vehicle 100. The data analysis component 206 may use a single driving parameter (or corresponding sensor signal) to determine a single current driving condition, or may use two or more driving parameters (or corresponding sensor signals) to determine one or more current driving condition. For instance, the data analysis component 206 can determine, one or more current driving conditions of the electric vehicle 100 using a first and second sensor signals received from two sensor devices.

The data analysis component 206 can determine, using the one or more current driving conditions, a future driving state indicative of an imminent future slowdown (e.g., a stop event or an active slowdown event) of the electric vehicle 100. As used herein, an active slowdown event represents an event where the driver of the electric vehicle 100 (or the electric vehicle 100 when in a self-driving or autonomous mode of operation) is expected to reduce the speed of the electric vehicle 100, for example, to avoid a potential collision event or adjust to current driving condition(s) (e.g., road curve, steep turn, or highway exit). For instance, an active slowdown event may occur when the electric vehicle 100 is approaching a traffic flow (or another vehicle ahead) that has an average speed smaller than the speed of the electric vehicle 100. An active slowdown event occurs when the electric vehicle 100 slows down using brakes but does not come to a stop. An active slowdown event may occur when exiting from a first road (e.g., a highway) having a first speed limit into a second road with a second speed limit smaller than the first speed limit, or when approaching a crossing with a yield sign (or flushing orange light). A stop event occurs when the electric vehicle 100 slows down till it stops. A stop event may occur when approaching a red light, a stop sign, pedestrians crossing the road, a non-moving traffic flow, an obstacle, or a combination thereof.

The data analysis component 206 can parse or process one or more driving condition vectors representing one or more corresponding current driving conditions to determine the presence (or absence) of a future driving state indicative of an imminent future slowdown. The data analysis component 206 may use one or more rules (or conditions) to determine the presence (or absence) of a future driving state indicative of an imminent future slowdown. Since an imminent future slowdown can occur according to different scenarios, the data processing system 202 may include, for example, a separate rule for each possible scenario. For example, one rule may specify that if the brake lights of a vehicle ahead of the electric vehicle 100 are on and the distance to the vehicle ahead is less than a predefined threshold value, then an imminent future slowdown exists. Another rule may specify that if the speed of a vehicle ahead of the electric vehicle 100 is less than the speed of the electric vehicle by more than a predefined threshold value, then an imminent future slowdown exists. This rule may include another condition related to existence of a side lane and whether there are other vehicles on the side lane preventing the electric vehicle from switching to another lane. Another rule may specify that a future stop event exists if a stop sign is within a predefined distance ahead of the electric vehicle 100. Another rule may specify a predefined distance to traffic lights and a red or yellow state of the traffic lights as indicative of the existence of future a stop event. Another rule may specify that a predefined distance to a highway exit that is within the navigation path of the electric vehicle is an indication of an imminent future slowdown event. Also, a predefined distance to a road segment with relatively slow traffic (e.g., average traffic speed is smaller than the speed of the electric vehicle 100 by at least a predefined amount, such as 10, 15 or 20 miles per hour (MPH)) can be indicative of an imminent future slowdown event. A predefined distance to an accident location (or road work activity location) that is along the navigation path of the electric vehicle 100 and is associated with traffic slowdown or traffic jam can be indicative of an imminent future slowdown event. A predefined distance to a road curve or a road crossing may also be an indication of an imminent future slowdown event.

The data analysis component 206 can evaluate one or more rules (or conditions) to determine the future driving state of the electric vehicle. The data analysis component 206 can perform the evaluation of the rules (or conditions) on a regular basis (e.g., periodically or repeatedly). If one of the rules (or conditions) is satisfied, the data analysis component 206 can determine that a future driving state of the electric vehicle 100 is indicative of an imminent future slowdown. However, if none of the rules (or conditions) is satisfied, then the data analysis component 206 can determine that future driving state of the electric vehicle 100 is not indicative of an imminent future slowdown event.

The data analysis component 206 can determine (e.g., through the evaluated rules or through additional processing) the type of any detected imminent future slowdown event. For instance, the data analysis component 206 can determine whether the imminent future slowdown event is a future stop event or a future active slowdown event. The rules may be classified into categories, such as a category for imminent stop events and another for imminent active slowdown events. The data analysis component 206 may also determine the amount of speed of the electric vehicle 100 to be reduced due to the detected imminent future slowdown event, for example, using the current speed of the electric vehicle, and a traffic (or vehicle) speed associated with a point of reference (e.g., stop sign, traffic lights, traffic accident location, road work activity location, highway exit, road segment associated with a traffic jam or traffic slowdown, road crossing, or a combination thereof). If an imminent future slowdown event is detected, the data analysis component 206 can send an indication of the future driving state (e.g., deceleration or speed reduction) of the electric vehicle 100 to the electric regeneration triggering component 208. The data analysis component 206 may send an indication of a time duration (e.g., based on time to or distance to the point of reference), the amount of speed to be reduced during the time duration, road topology (e.g., road curve, steep turn, uphill, downhill, road type, or a combination thereof), weather condition, or a combination thereof. If no imminent future slowdown event is detected, the data analysis component 206 may not send an indication of the future driving state of the electric vehicle 100 to the electric regeneration triggering component 208.

The electric regeneration triggering component 208 can cause the regenerative braking system 114 of the electric vehicle 100 to apply regenerative braking, responsive to determining that the future driving state is indicative of an imminent future slowdown event. The electric regeneration triggering component 208 can receive the indication(s) from the data analysis component 206, and send and instruction, command or signal to the regenerative braking system 114. The regenerative braking system 114 can apply regenerative braking, responsive to received instruction, command or signal. The electric regeneration triggering component 208 can determine, using for example information received from the data analysis component 206, a level of regenerative braking to be applied by the regenerative braking system 114. For example, the electric regeneration triggering component 208 can use information indicative of time to (or distance to) the point of reference, the amount of speed to be reduced or a combination thereof to determine a level of regenerative braking. The electric regeneration triggering component 208 may use information indicative of road topology (e.g., road curve, steep turn, uphill, downhill, road type, or a combination thereof) or weather condition to determine the level of regenerative braking (e.g., among a plurality of predefined levels) to be applied. A regenerative braking level can define the amount of braking force or torque to be applied, the time duration during which to apply the braking force or torque, the wheels to which to apply the braking force or torque, or a combination thereof. The electric regeneration triggering component 208 may use a lookup table (or other data structure), heuristics, mathematical equations, or a combination thereof to determine regenerative braking level. For example, a lookup table can map value ranges associated with one or more parameters (e.g., amount of speed reduction, time duration, road topology information, weather condition parameters) to corresponding regenerative braking levels. The mapping between the value ranges associated with one or more parameters and the regenerative braking levels can be defined offline (e.g., based on experimental data, statistical data, or a combination thereof) and stored in a memory of (or communicatively coupled to) the data processing system 202.

The data processing system 202 may collect historical driving parameters of the electric vehicle 100, determine driving preferences of a driver of the electric vehicle 100 using the driving parameters, and determine the future driving state based at least in part on the driving preferences. For example, the data processing system 202 may collect driving parameters data such as, speed values of the electric vehicle 100 in association with the type of road traveled, speed values of the electric vehicle 100 at road curves, number or frequency of lane switching, intensity and duration of pressing brakes, distance to vehicle ahead, or a combination thereof. The collected historical parameters can be indicative of the driver's preferences or driving habits. For instance, the collected data can provide information regarding, for example, how fast the driver drives through road curves, road crossing, or highway exits, whether the driver applies smooth braking through relatively longer periods of time or applies sharp or steep braking over shorter periods of time, how often does the driver comply with speed limits, whether the driver is more likely to maintain the current lane or more likely to switch lanes, for example, when traffic or the vehicle ahead is slower than the electric vehicle 100, or a combination thereof. The data processing system 202 (or a remote server receiving the collected data from the data processing system 202) can use the collected historical data in constructing or updating the rules (or conditions) used to detect imminent future slowdown events. For example, the data processing system 202 (or a remote server) can use the collected historical data to set predefined threshold values (e.g., predefined distances to vehicles ahead or other reference points, predefined speed difference values, or a combination thereof) used in the rules (or conditions) used to detect imminent future slowdown events. The data processing system 202 (or the remote server) can use the collected historical data to determine the conditions or checks to be included in each rule. For instance, if the historical data indicates that the driver is more likely to change lanes as traffic or a vehicle ahead is slower, the data processing system 202 (or the remote server) may consider checking for vehicles on side lanes as part of a rule (or condition) for detecting imminent future slowdown events, for example, when a vehicle ahead is slower than the electric vehicle 100.

FIG. 3 depicts a flowchart of an example method 300 of automatic regenerative braking in electric vehicles. The method 300 can include acquiring (or sensing) sensor data or signals associated with an electric vehicle (ACT 302). The method 300 can include determining a current driving condition of the electric vehicle (ACT 304). The method 300 can include determining a future driving state of the electric vehicle (ACT 306). The method 300 can include triggering regenerative braking in the electric vehicle (ACT 308).

The method 300 can be performed according to processes and details described above with regard to FIGS. 1 and 2. The method 300 can be performed by an electric vehicle such as the electric vehicle 100 of FIG. 1, by a system of automatic (or adaptive) regenerative braking such as the system 200 of FIG. 2, or by executing computer code instructions (e.g., by a computing device of an electric vehicle or one or more processors thereof) stored in a computer-readable medium. The method 300 can be performed by self-driven electric vehicles (or electric vehicles while in self-driving or manual mode of operation) or by driver-driven electric vehicles (or electric vehicles while in driver-driving mode).

The method 300 can include one or more sensors disposed in the electric vehicle 100 sensing one or more sensor signals indicative of one or more respective driving parameters of the electric vehicle (ACT 302). The sensor signals (or sensor data) can be acquired by one or more radar sensors 102, one or more image sensors 104, a radio transceiver 106, a navigation device 108, a vehicle speed sensor (VS S), a battery sensor, one or more pressure monitoring sensors to monitor wheel pressure, one or more engine sensors, or a combination thereof. The driving parameters can include the vehicle's speed, the vehicle's orientation, distance(s) to (or location(s) of) one or more other vehicles or obstacles, speed of one or more other vehicles, average traffic speed in one or more road segments, location(s) and type(s) (e.g., stop sign, yield sign, speed limit sign, school zone sign, sign of merging lanes, or rail road crossing sign) of traffic signs, location(s) and state(s) (e.g., red, green or orange) of traffic lights, distance(s) to one or more road exits ahead, distance to (or location of) traffic accident if any, distance to (or location of) road work activity if any or indication of any closed lanes or detours, navigation path, type of road (e.g., highway, urban road, rural road, number of lanes, or a combination thereof) traveled by the electric vehicle 100, speed limit in the road traveled by the electric vehicle 100, state(s) of brake light(s) of one or more other vehicles, the battery charging level of the electric vehicle 100, tires' pressure levels, coolant temperature, the electric vehicle doors' locked status, maintenance parameters (or alerts) of the electric vehicle 100, weather parameters (e.g., rain, snow, ambient temperature or a combination thereof), self-driving status (e.g., on or off), or a combination thereof.

The method 300 can include determining a current driving condition of the electric vehicle (ACT 304). For example, the data processing system 202 can determine one or more current driving conditions of the electric vehicle 100. The current driving condition(s) can include information related to a road topography of a road traveled by the electric vehicle, a speed (or speed difference) of the electric vehicle 100 relative to a second speed of one or more other vehicles ahead of the electric vehicle 100, a traffic condition ahead of the electric vehicle, a current location of the electric vehicle relative to one or more other vehicles in the vicinity of the electric vehicle, or a combination thereof. As discussed above with respect to FIG. 2, each driving condition can be defined by (or using) a respective set of driving parameters. Also, each driving condition may be defined through a vector of values or as a single value determined using the values of the driving parameters associated with that driving condition, as discussed with regard to FIG. 2 above. The driving conditions may be defined according to various different implementations. For instance, the number of driving conditions, the length and content of each driving condition vector, or the driving parameters used to define each driving condition associated may vary for distinct implementations. The data processing system 202 may update the driving condition vector(s) on a regular basis (e.g., periodically or otherwise) using driving parameters acquired from corresponding sensor devices. As such, the driving condition vector(s), at any point in time, can reflect the current driving condition(s) of the electric vehicle 100.

The method 300 can include determining a future driving state of the electric vehicle 100 indicative of an imminent future slowdown event, using the one or more current driving conditions (ACT 306). The imminent slowdown event can include a future stop event or future active slowdown event. The data processing system 202 may determine the future driving state of the electric vehicle by parsing or processing one or more driving condition vectors representing one or more corresponding current driving conditions. As discussed above with regard to FIG. 2, the data processing system may use (or evaluate) one or more rules (or conditions) to determine the future driving state of the electric vehicle 100. The data processing system 202 can perform the evaluation of the rules (or conditions) on a regular basis (e.g., periodically or repeatedly). If one of the rules (or conditions) is satisfied, the data processing system 202 can determine that the future driving state of the electric vehicle 100 is indicative of an imminent future slowdown. However, if none of the rules (or conditions) is satisfied, then the data processing system 202 can determine that the future driving state of the electric vehicle 100 is not indicative of an imminent future slowdown event. The data processing system 202 may determine (e.g., through the evaluated rules or through additional processing) the type of any detected imminent future slowdown event (e.g., a future stop event or a future active slowdown event), the amount of speed reduction to be achieved through automatic regenerative braking, or a combination thereof.

The method 300 can include the data processing system 202 triggering regenerative braking, responsive to determining a future driving state indicative of an imminent future slowdown event (ACT 308). If an imminent future slowdown event is detected, the data processing system 202 can actuate the regenerative braking system 114 to cause it to apply regenerative braking force or torque to one or more wheels of the electric vehicle 100. If no imminent future slowdown event is detected, the data processing system 202 may not actuate the regenerative braking system 114.

The data processing system 202 can determine a level of regenerative braking to be applied by the regenerative braking system 114. As discussed with respect to FIG. 2, the data processing system 202 can use information indicative of time to (or distance to) the point of reference, the amount of speed to be reduced, road topology (e.g., road curve, steep turn, uphill, downhill, road type, or a combination thereof), weather conditions, or a combination thereof to determine a level of regenerative braking. A regenerative braking level may define the amount of braking force or torque to be applied, the time duration during which to apply the braking force or torque, the wheels to which to apply the braking force or torque, or a combination thereof. The data processing system 202 may use a lookup table (or other data structure), heuristics, mathematical equations, or a combination thereof to determine regenerative braking level. For example, a lookup table can map value ranges associated with one or more parameters (e.g., amount of speed reduction, time duration, road topology information, weather condition parameters) to corresponding regenerative braking levels. The mapping between the value ranges associated with one or more parameters and the regenerative braking levels can be defined offline (e.g., based on experimental data, statistical data, or a combination thereof) and stored in a memory of (or communicatively coupled to) the data processing system 202.

The method 300 can include the data processing system 202 may collect historical driving parameters of the electric vehicle 100, determining driving preferences of a driver of the electric vehicle 100 using the driving parameters, and determining the future driving state based at least in part on the driving preferences. The data processing system 202 may collect driving parameters data such as, speed values of the electric vehicle 100 in association with the type of road traveled, speed values of the electric vehicle 100 at road curves, number or frequency of lane switching, intensity and duration of pressing brakes, distance to vehicle ahead, or a combination thereof. The collected historical parameters can be indicative of the driver's preferences or driving habits. For instance, the collected data can provide information regarding, for example, how fast the driver drives through road curves, road crossing, or highway exits, whether the driver applies smooth braking through relatively longer periods of time or applies sharp or steep braking over shorter periods of time, how often does the driver comply with speed limits, whether the driver is more likely to maintain the current lane or more likely to switch lanes, for example, when traffic or the vehicle ahead is slower than the electric vehicle 100, or a combination thereof. The data processing system 202 (or a remote server receiving the collected data from the data processing system 202) can use the collected historical data in constructing or updating the rules (or conditions) used to detect imminent future slowdown events. For example, the data processing system 202 (or a remote server) can use the collected historical data to set predefined threshold values (e.g., predefined distances to vehicles ahead or other reference points, predefined speed difference values, or a combination thereof) used in the rules (or conditions) used to detect imminent future slowdown events. The data processing system 202 (or the remote server) can use the collected historical data to determine the conditions or checks to be included in each rule. For instance, if the historical data indicates that the driver is more likely to change lanes as traffic or a vehicle ahead is slower, the data processing system 202 (or the remote server) may consider checking for vehicles on side lanes as part of a rule (or condition) for detecting imminent future slowdown events, for example, when a vehicle ahead is slower than the electric vehicle 100.

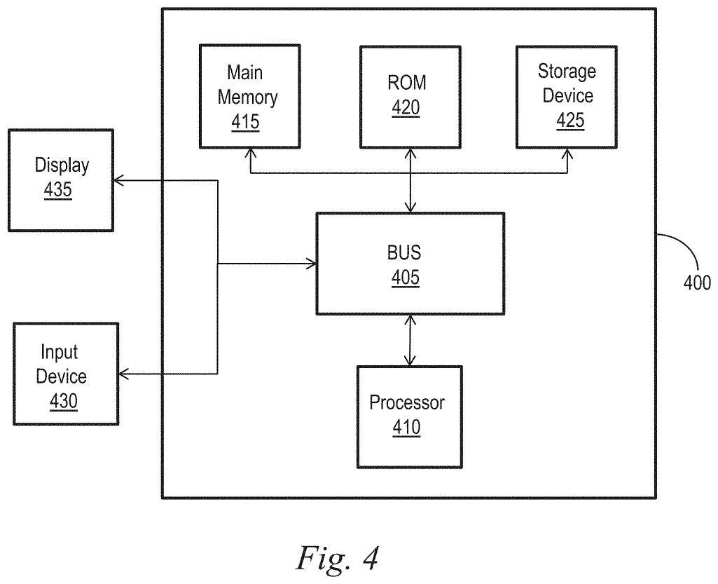

FIG. 4 is a block diagram of an example computer system 400. The computer system or computing device 400 can include or be used to implement the computing device 110 in FIG. 1, a remote server communicatively coupled to the computing device 110, the data processing system 202 in FIG. 2, or components thereof. The computing system 400 can include at least one bus 405 or other communication component for communicating information and at least one processor 410 or processing circuit coupled to the bus 405 for processing information. The computing system 400 can include at least one main memory 415, such as a random access memory (RAM) or other dynamic storage device, coupled to the bus 405 for storing information, and instructions to be executed by the processor 410. The main memory 415 can also be used for storing sensor data or driving parameters, driving conditions or parameters thereof, future driving state, information indicative of regenerative braking levels, data structures such as a lookup table for mapping driving conditions (or parameters related thereto) to corresponding regenerative braking levels, or other information during execution of instructions by the processor 410. The computing system 400 may further include at least one read only memory (ROM) 420 or other static storage device coupled to the bus 405 for storing static information and instructions for the processor 410, such as historical data indicative of driver's preferences and driving habits collected by the computing system 400, lookup tables or other data structures, or a combination thereof. A storage device 425, such as a solid state device, magnetic disk or optical disk, can be coupled to the bus 405 to persistently store information and instructions.

The computing system 400 may be coupled via the bus 405 to a display 435, such as a liquid crystal display, or active matrix display, for displaying information to a user such as a driver of the electric vehicle 100. The display 435 may include or be part of the display device 112. An input device 430, such as a keyboard or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435. The display 435 (e.g., on a vehicle dashboard) can be part of the data processing system 200, the sensors 210, the communication transceiver 212, the navigation device 214, or other component of FIGS. 1 and 2, for example.

The processes, systems and methods described herein can be implemented by the computing system 400 in response to the processor 410 executing an arrangement of computer code instructions contained in main memory 415. Such instructions can be read into main memory 415 from another computer-readable medium, such as the storage device 425. Execution of the arrangement of instructions contained in main memory 415 causes the computing system 400 to perform the illustrative processes, or any combination thereof, described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., communications interface 204, data analysis component 206, or electric regenerative triggering component 208). Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. A system of automatic off-throttle regenerative braking in electric vehicles, comprising:
a first sensor disposed in an electric vehicle to provide a first sensor signal indicative of a first driving parameter of the electric vehicle;
a second sensor disposed in the electric vehicle to provide a second sensor signal indicative of a second driving parameter of the electric vehicle; and
a data processing system of the electric vehicle, the data processing system comprising a communications interface, a data analysis component, and an electric regeneration triggering component,
the communications interface to receive the first and second sensor signals from the first and second sensors, respectively;
the data analysis component to determine, based on the first and second sensor signals, one or more current driving conditions of the electric vehicle;
the data analysis component to determine, based on the one or more current driving conditions, a future driving state indicative of an imminent slowdown of the electric vehicle velocity; and
the electric regeneration triggering component to cause a regenerative braking system of the electric vehicle to apply regenerative braking, responsive to determination of the future driving state.

2. The system of claim 1, comprising:
the first sensor to provide a third sensor signal indicative of the first driving parameter of the electric vehicle;
the second sensor to provide a fourth sensor signal indicative of the second driving parameter of the electric vehicle;
the communications interface to receive the third and fourth sensor signals from the first and second sensors, respectively;
the data analysis component to determine, using the third and fourth sensor signals, one or more other current driving conditions of the electric vehicle;
the data analysis component to determine, using the one or more other current driving conditions, a second future driving state not indicative of an imminent slowdown of the electric vehicle velocity; and
the electric regeneration triggering component to determine not to trigger regenerative braking responsive to determining the second future driving state.

3. The system of claim 1, comprising the data analysis component to:
detect a future stop event along a route of the electric vehicle using the first and second sensor signals; and
determine the future driving state responsive to detecting the future stop event.

4. The system of claim 3, comprising the data analysis component to:
detect the future stop event by detecting one or more traffic lights along the route of the electric vehicle; or
detect the future stop event by detecting a road crossing along the route of the electric vehicle.

5. The system of claim 1, wherein the electric vehicle is a first vehicle and the data analysis component to:
detect at least one of a speed of a second vehicle ahead of the first vehicle and a distance to the second device; and
determine the future driving state responsive to detecting the at least one of the speed of the second vehicle and the distance to the second vehicle.

6. The system of claim 1, comprising the data analysis component to:
receive, from a navigation device, traffic information indicative of a traffic state ahead of the electric vehicle; and
determine the future driving state responsive to the traffic information.

7. The system of claim 1, wherein the one or more current driving conditions include information related to at least one of:
a road topography of a road traveled by the electric vehicle;
a first speed of the electric vehicle relative to a second speed of one or more other vehicles ahead of the first vehicle;
a traffic condition ahead of the electric vehicle; or
a current location of the electric vehicle relative to one or more other vehicles in the vicinity of the electric vehicle.

8. The system of claim 1, comprising the electric regeneration triggering component to:
determine, based on the future driving state, an electric regeneration level; and
cause the regenerative braking system of the electric vehicle to apply regenerative braking according to the electric regeneration level.

9. The system of claim 1, comprising an interactive user interface component for turning on automatic off-throttle regenerative braking.

10. The system of claim 1, wherein the first and second sensors include at least one of:
a global positioning system (GPS) receiver;
a vehicle speed sensor;
a radar sensor; or
an image sensor.

11. The system of claim 1, wherein the electric vehicle is an autonomous vehicle in a manual mode of operation.

12. The system of claim 1, comprising the data processing system to:
collect historical driving parameters;
determine driving preferences of a driver of the vehicle using the driving parameters; and
determine the future driving state based at least in part on the driving preferences.

13. A method of automatic off-throttle regenerative braking in electric vehicles, the method comprising:
sensing, by one or more sensors disposed in an electric vehicle, one or more sensor signals indicative of one or more respective driving parameters of the electric vehicle;
determining, by a data processing system of the electric vehicle, using the one or more sensor signals, one or more current driving conditions of the electric vehicle;
determining, by the data processing system of the electric vehicle, using the one or more current driving conditions, a future driving state indicative of an imminent slowdown of the electric vehicle velocity; and
causing, by the data processing system of the electric vehicle, a regenerative braking system of the electric vehicle to apply regenerative braking, responsive to determining the future driving state.

14. The method of claim 13, comprising:
determining, based on the future driving state, an electric regeneration level; and
causing the regenerative braking system of the electric vehicle to apply regenerative braking according to the electric regeneration level.

15. The method of claim 13, comprising:
detecting a future stop event along a route of the electric vehicle using the first and second sensor signals; and
determining the future driving state responsive to detecting the future stop event.

16. The method of claim 13, comprising:
detecting at least one of a speed of a second vehicle ahead of the first vehicle and a distance to the second device; and
determining the future driving state responsive to detecting the at least one of the speed of the second vehicle and the distance to the second vehicle.

17. The method of claim 13, comprising:
receiving, by the data processing system of the electric vehicle, from a navigation device, traffic information indicative of a traffic state ahead of the electric vehicle; and
determining the future driving state responsive to the traffic information.

18. The method of claim 13, wherein the one or more driving conditions include information related to at least one of:
a road topography of a road traveled by the electric vehicle;
a first speed of the electric vehicle relative to a second speed of one or more other vehicles ahead of the first vehicle;
a traffic condition ahead of the electric vehicle; or
a current location of the electric vehicle relative to one or more other vehicles in the vicinity of the electric vehicle.

19. The method of claim 13, wherein the electric vehicle is an autonomous vehicle.

20. An electric vehicle, comprising:
a first sensor disposed in the electric vehicle to provide a first sensor signal indicative of a first driving parameter of the electric vehicle;
a second sensor disposed in the electric vehicle to provide a second sensor signal indicative of a second driving parameter of the electric vehicle;
a data processing system of the electric vehicle, the data processing system comprising a communications interface, a data analysis component, and an electric regeneration triggering component,
the communications interface to receive the first and second sensor signals from the first and second sensors, respectively;
the data analysis component to determine, using the first and second sensor signals, one or more current driving conditions of the electric vehicle;
the data analysis component to determine, using the one or more current driving conditions, a future driving state indicative of an imminent slowdown of the electric vehicle velocity; and
the electric regeneration triggering component to cause a regenerative braking system of the electric vehicle to apply regenerative braking, responsive to determining the future driving state.
